(19) United States
(12) Patent Application Publication
(10) Pub. No.: US 2025/0042088 A1
(43) Pub. Date: Feb. 6, 2025

(54) MICRO GRAVITY 3D PRINTER AND METHOD

(71) Applicant: Orbital Construction Pioneers Inc., Colorado City, TX (US)

(72) Inventors: George Richard Tyson, Colorado City, TX (US); Bryan Richard Athan, Colorado City, TX (US); Bryan Bernard Kuklinski, Wauwatosa, WI (US)

(73) Assignee: Orbital Construction Pioneers Inc., Colorado City, TX (US)

(21) Appl. No.: 18/792,458

(22) Filed: Aug. 1, 2024

Related U.S. Application Data
(60) Provisional application No. 63/530,843, filed on Aug. 4, 2023.

(51) Int. Cl. B29C 64/25; B29C 64/232; B29C 64/241; B29C 64/282; B29C 64/321; B33Y 10/00; B33Y 30/00; B64G 4/00

(52) U.S. Cl. CPC B29C 64/25; B29C 64/232; B29C 64/241; B29C 64/282; B29C 64/321; B64G 4/00; B33Y 10/00; B33Y 30/00

(57) ABSTRACT

A micro-gravity three-dimensional printer is disclosed, featuring a framed structure supporting a movable printing arm for printing three-dimensional objects. The printer includes a stabilizing arm extending from the framed structure and one or more stabilizing devices to prevent movement of the framed structure in a micro-gravity environment. The stabilizing arm and devices ensure the stability of the printer during printing operations in a micro-gravity setting, allowing for precise and accurate printing of three-dimensional objects. The innovative design of the printer enables efficient and reliable operation in space or other micro-gravity environments, making it ideal for manufacturing and prototyping applications in such conditions.

This application claims the benefits of U.S. provisional patent application No. 63/530,843 filed on Aug. 4, 2023, the contents of which are hereby incorporated by reference.

### TECHNICAL FIELD

These claimed embodiments relate to an apparatus for printing a 3-dimensional object in a micro-gravity environment and more particularly to a stabilized platform supporting a printing arm to print the object.

### BACKGROUND OF THE INVENTION

A device for printing a three-dimensional object in a micro-gravity environment is disclosed.

Previous approaches to three-dimensional (3-D) printing in micro-gravity environments have typically involved adapting traditional 3-D printers for use in space. These adaptations have included modifications to account for the lack of gravity, such as the use of specialized materials and structures to ensure proper adhesion and layering of printing materials. Additionally, stabilizing mechanisms have been employed to prevent unintended movements of the printer during the printing process in micro-gravity conditions. However, these adaptations have often been complex and have not fully addressed the challenges associated with printing in a micro-gravity environment.

In some instances, micro-gravity 3-D printers have utilized robotic arms or other movable structures to facilitate the printing process. These systems have aimed to provide flexibility and precision in printing objects in space. However, the integration of stabilizing mechanisms to counteract the effects of micro-gravity on the printing process has been limited, leading to potential issues with print quality and accuracy. Furthermore, the reliance on external stabilizing devices or structures has added complexity to the overall system, making it less efficient and potentially less reliable for use in space missions.

Efforts to develop micro-gravity 3-D printers have also focused on enhancing the overall stability and control of the printing process. Various approaches have been explored to ensure that the printing arm or nozzle remains steady and accurate during printing operations in a micro-gravity environment. While these efforts have shown some progress in improving the reliability of printing in space, challenges remain in achieving a comprehensive solution that addresses both the printing process and the stability of the printer itself. However, none of these approaches have provided a comprehensive solution that combines the features described in this disclosure.

### SUMMARY OF THE INVENTION

In some aspects, the techniques described herein relate to a micro-gravity three-dimensional printer including: a framed structure supporting a movable printing arm, the printing arm operative to print a three-dimensional (3-D) object; a stabilizing arm coupled with and extending away from the framed structure; and one or more stabilizing devices coupled with the framed structure to prevent movement of the framed structure in a micro-gravity environment.

In some aspects, the techniques described herein relate to a method for printing three-dimensional (3-D) object in a micro-gravity environment including: supporting a movable printing arm with a frame structure of a 3-D printer; coupling a stabilizing arm to the framed structure; preventing movement of the framed structure in a micro-gravity environment using one or more stabilizing devices coupled with the framed structure; and printing a 3-D object with the printing arm.

In some aspects, the techniques described herein relate to a micro-gravity three-dimensional (3-D) printer including: a framed structure supporting a movable printing arm, media tanks and a material platform, the printing arm rotatably coupled with the frame structure at one end and coupled with one or more print heads disposed at another end of the printing arm, configured to print a 3-D object on the platform by injecting material in the media tanks via the print head; a stabilizing arm coupled with and extending away from the framed structure having a movable counterbalance configured to move laterally along the stabilizing arm in response to Newtonian forces or gravitational forces on the printer; and one or more stabilizing devices that include one or more thrusters coupled with the framed structure to prevent movement of the framed structure in a micro-gravity environment when printing the 3-D object.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIGS. 1-5 are elevated views of a micro-gravity 3-dimensional printer showing printing in consecutive stages of a 3-dimensional object.

FIG. 6A is an elevated view of an alternative embodiment of the micro gravity 3-dimensional printer having the print head embedded in an array of ultraviolet light elements.

FIG. 6B is an elevated view of the print head embedded in an array of ultraviolet light elements shown in FIG. 6A.

### DETAILED DESCRIPTION

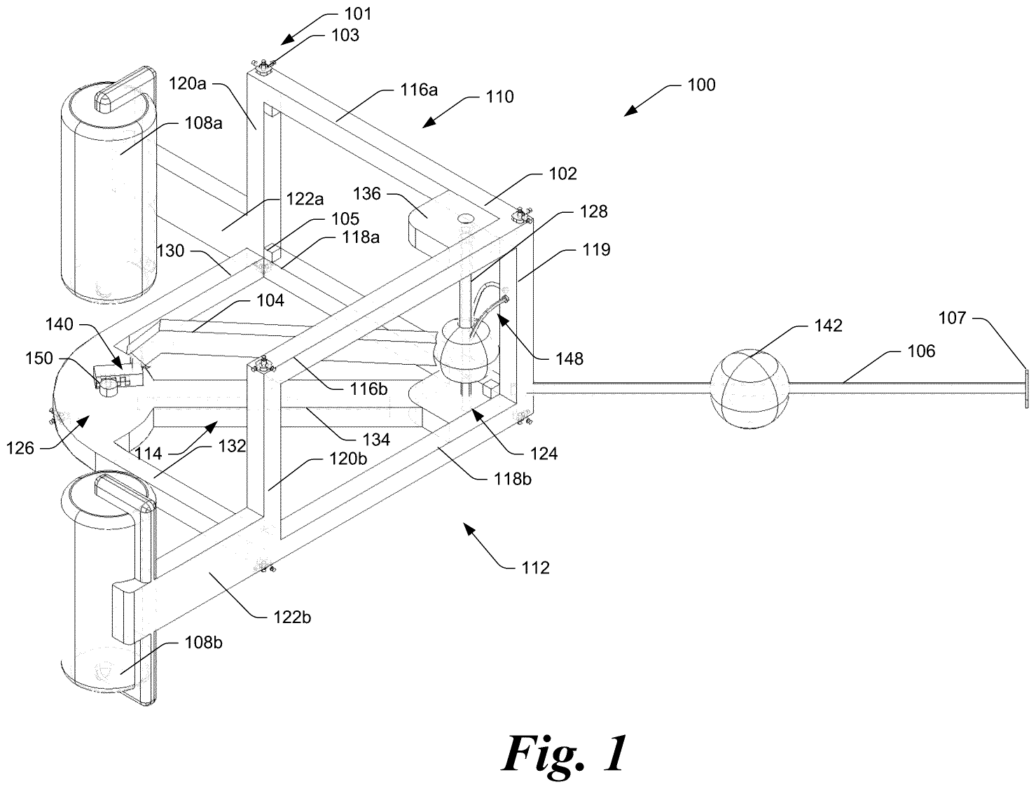

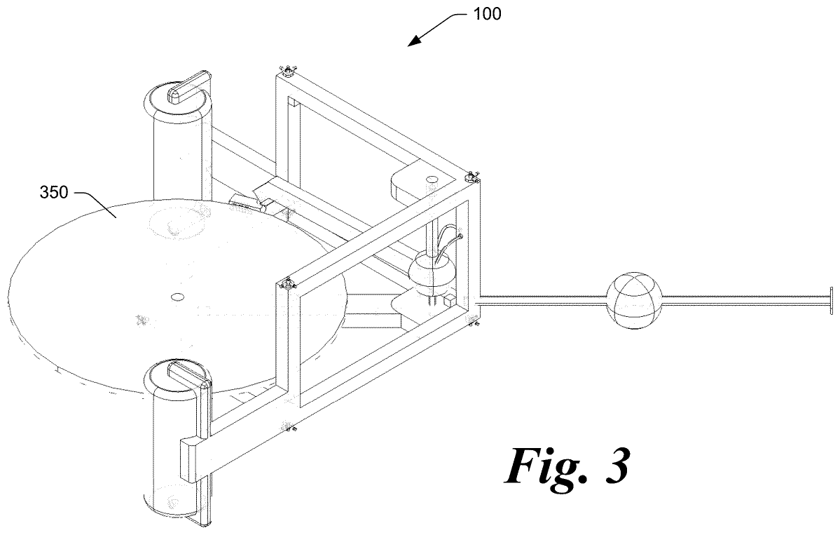

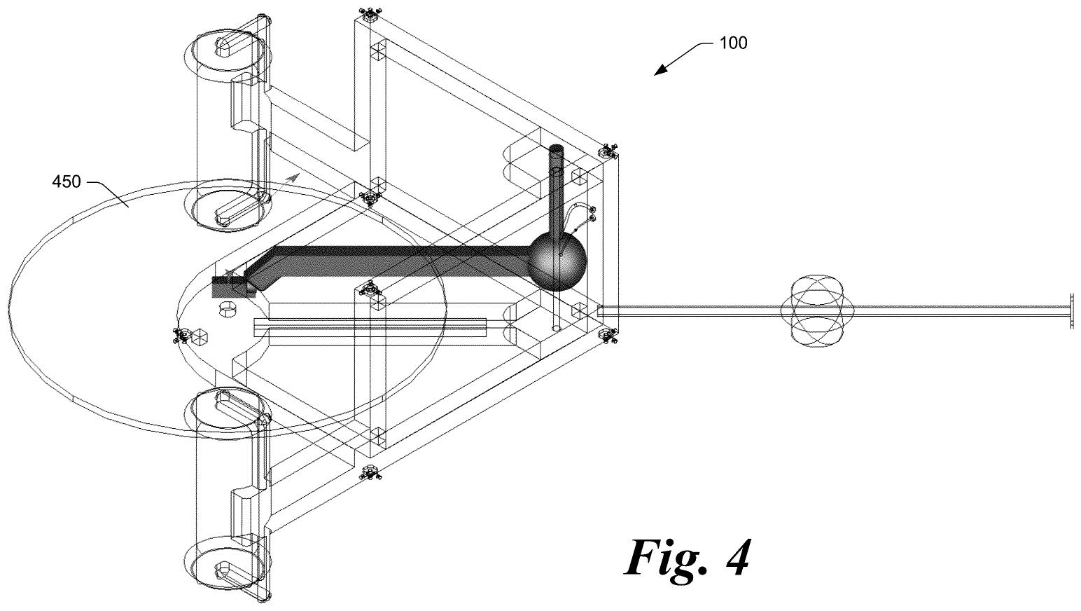

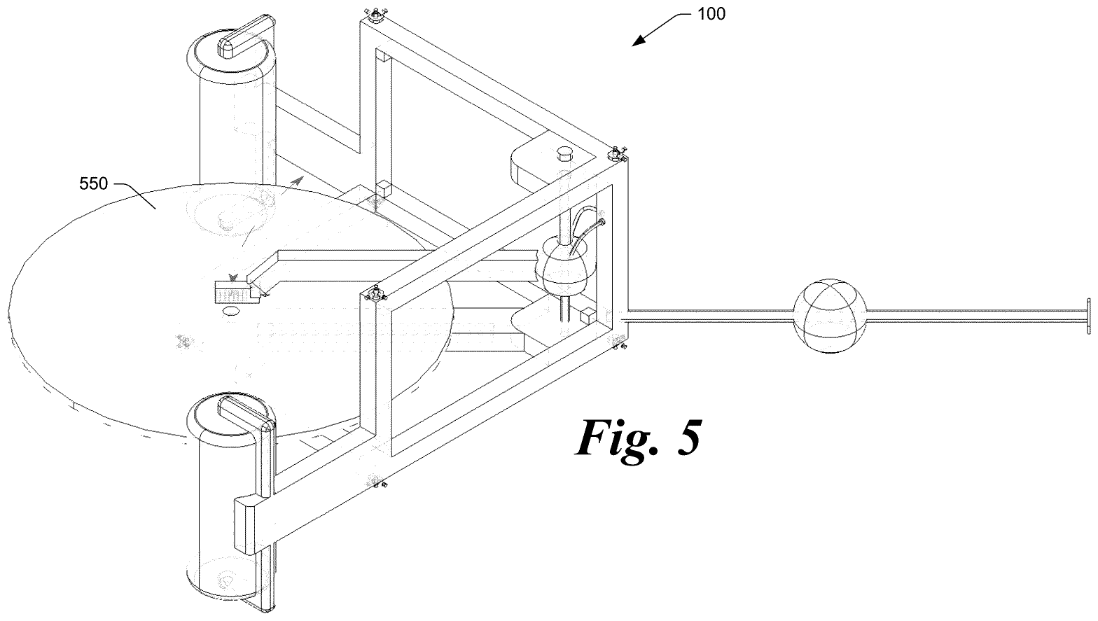

Referring to FIGS. 1-5, there is shown the same micro-gravity three-dimensional printer 100 in various and consecutive stages of printing of a 3-dimensional (3-D) object.

Referring to FIG. 1, micro-gravity 3D printer 100 includes a framed structure 102 supporting a movable printing arm 104 operative to print a 3-dimensional object. Extending away from and coupled to framed structure 102 is stabilizing arm 106 (also referred to herein as a gravity differential stinger). Several stabilizing devices 101, which include thrusters 103 and gyros 105, are coupled with the framed structure 102 to prevent and/or counteract reactionary movement of the framed structure 102 in a micro-gravity environment. Media tanks 108a and 108b are coupled with the frame structure and store material to create a three-dimensional object or plug 150 as described herein.

Framed structure 102 includes right side vertical frame bars 110, left side vertical frame bars 112, and floor horizontal bars 114. Vertical frame bars 110 and 112 include a top bar 116a and 116b that extend parallel to bottom bars 118a and 118b respectively. Vertical frame bars 110 and 112 have a common frame bar 119 that joins top bars 116a and 116b to bottom bars 118a and 118b at a first end. Frame bars 120a and 120b join top bars 116a and 116b to bottom bars 118a and 118b respectively, at the other (second) end of top bars 116a and 116b, to bottom bars 118a and 118b. Tab bars 122a and 122b extend outward from frame bars 120a and 120b respectively and are coupled with media tanks 108a and 108b respectively to hold media tanks 108a and 108b in an orientation parallel to common frame bar 119.

Floor horizontal bars 114 include a lower arm platform 124 and a material platform 126. Lower arm platform 124 is coupled to bottom bars 118a and 118b to engage with one end of vertical rod 128. Vertical rod 128 engages with one end of printing arm 104. Material platform 126 integrally couples with horizontal bars 130, 132 and 134. Horizontal bars 130, 132 and 134 extend away from material platform 126 to respectively engage with bottom bars 118a and lower arm platform 124. Engaging upper bars 116a and 116b is upper arm platform 136 that engages with the other end of vertical rod 128.

Disposed at the other end of printing arm 104 is a print head assembly 140, which extends over material platform 126. Material is released from media tanks 108a and 108b and flows via the print head assembly 140 to form a 3-D object or plug 150 and material platform 126. Arm 104 may rotate about an axis extending through and parallel to vertical rod 128 during a printing process. Arm 104 may also move vertically up and down on vertical rod 128 toward or away from material platform 126 during the printing process.

To reduce vibration during the printing process, in response to reactions from environmental forces, a cable/feed tube controller adjusts flow of media into the print head assembly 140. Print head assembly 140 will be mounted on the end of arm 104 similar to an arm found on a turntable. Print head assembly 140 (also referred to as a print head array) includes multiple nozzles on multiple print heads that can be independently adjusted and turned on based on angles or distance to printed object. Further a rate of flow of media into assembly print heads can be individually turned on/off. An angle of the print head assembly 140 with respect to the printed three dimensional object or plug 150 can be adjusted using a processor and print head assembly controller (not shown) so that print head assembly 140 can print from an edge of a wheel (tread part of a tire) to a platter (side wall of a tire).

Print head assembly 140 may rotate about an axis extending laterally or longitudinally along arm to allow for further printing on a surface of a flat side of the initial printed 3-D object, e.g., plug 150. Specifically the entire print head assembly 140 may be configured to rotate so that additional printing can be performed on a surface of the flat side of the previously printed shape (i.e., the initial print could be printed along an outside edge or perimeter of the printed object or plug 150 first, but then the printhead array could be rotated (e.g., +/−) 90° about the axis on the end of the arm 104 to print additional material on top of the object or plug 140 surface as well.

Stabilizing arm 106 (also referred to as a gravity differential stinger) coupled with common frame bar 119 and extends away from rod 128 in the opposite direction of material platform 126 to provide printer stabilization. Stabilizing arm 106 may integrally connect with a movable counterbalance (such as spherical object 142) located about a midpoint of arm 106. Object 142 is operative to move laterally along arm 106 in response to a signal from a controller (not shown) to stabilize the printer 100 in response to Newtonian forces or gravitational forces (of planets, special objects and/or moons) experienced by the printer 100 using gyro's or other gravity sensing equipment coupled with the controller. Arm 106 consists of a long pole or structure, with a stop plate 107 on the distal end of the long pole pointed toward the celestial object. The length and weight of arm 106 may be determined by a gravity field in which printer 100 will operate. The higher the gravity field (i.e., the larger the celestial object near printer 100) the shorter and lighter the requirements are for arm 106.

Stabilizing thrusters 103 provide thrust to micro gravity 3-dimensional printer 100 to maintain printer 100 in a free float in orbit around a planet, moon, or other celestial object. Thus, micro gravity 3-dimensional printer 100 may be completely self-contained and not attached to any other structure or body. Printer 100 may also be coupled with gyros 105, which may be used to provide additional printer 100 stabilization during the printing process.

Material used to create 3 dimensional object or plug 150 may be stored in a heated and/or cooled storage container (not shown) adjacent rod 128 or media tanks 108a and 108b. Such material may be injected through tubes 148 and into arm 104 and released via print head assembly 140.

During operation print head injects material to create 3 dimensional object or plug 150 above platform 126. The material used in the creation of the 3 dimensional objects or plug 150 will consist of a polymer for binder and regolith for filler. The type of polymer can range from photoreactive to two-part epoxies. The type of polymer and the mix ratio of binder to filler will be selected based on the use of the printed object.

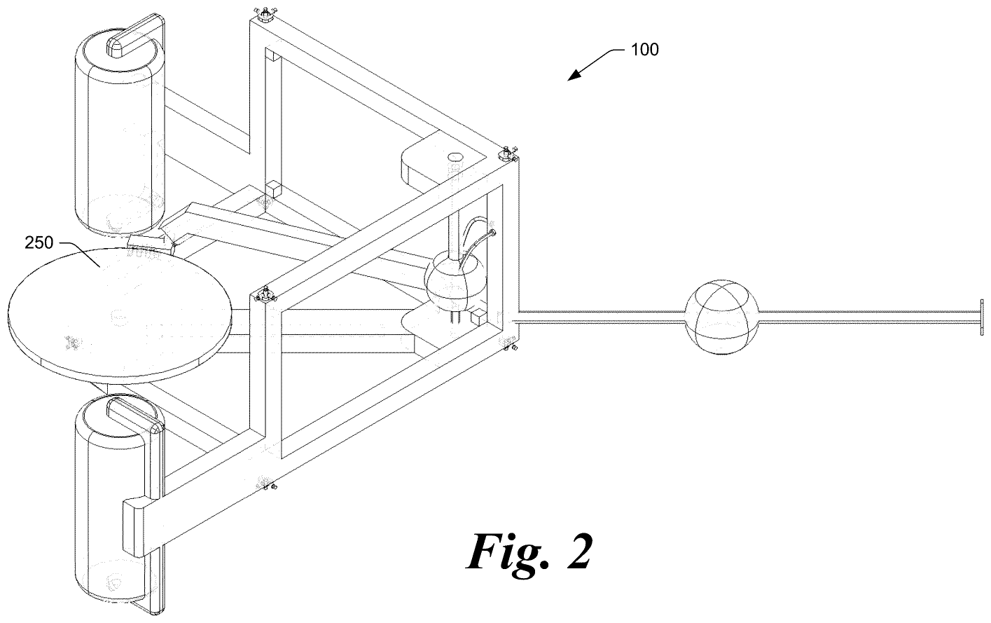

The process of printing will begin with the creation of a 3 dimensional object or (circular) plug 150 similar to the size and shape of a solid tire as shown in FIG. 1 using print head assembly 140. The 3 dimensional object or plug 150 is mounted on platform 126 such that the print heads are pointed at the edge (tread side of tire) and the material is added from the material storage container or tanks 108a and 108b via arm 104 as the 3 dimensional object or plug 150 is rotated. With each layer the plug grows (see plugs 250, 350, 450 and 550 in FIGS. 2-5) to form an object until the object increases in size and reaches the desired diameter as shown in FIGS. 2-5 respectively. The object being constructed (plug 550) may be formed as and then act as a circular platter. Different geometric shapes can be created from 3 dimensional object or plug 150 by adding material in specific places on the 3 dimensional object or plug 150 as the object rotates.

At any time during the process, the print head assembly 140 can be turned up to 90 degrees resulting in a configuration like a record player where the needle is the print head assembly 140. As 3 dimensional object or plug 150 rotates, new material can be placed on or about 3 dimensional object or plug 150 to create an object with various 3-dimensional shapes and sizes.

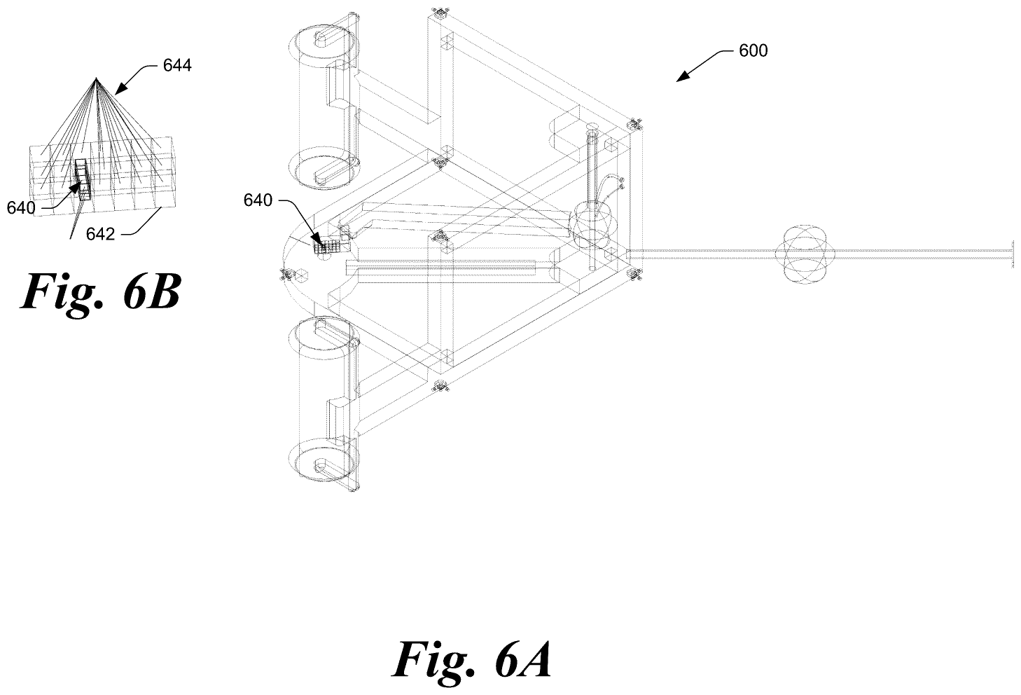

Referring to FIGS. 6A and 6B, there is shown an alternate implementation of printer head assembly 640 (Print head assembly 140 in FIG. 1) on printer 600 (Printer 100 in FIG. 1). Print head assembly 640 may include multiple print heads and may be at least partially surrounded by an array of light (ultra-violet) generation source array 642, such as an array of laser generators or ultra-violet (UV) light array elements (e.g., an LED light or laser generator). One or more elements within the light generation source array 642 may be selectively turned off and on by the controller to direct UV light 644 at a 3-D object being generated (e.g., 3 dimensional object or plug 150) to cure, harden or shape the 3-D object.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion but should be defined by the appended claims.

What is claimed is:

1. A micro-gravity three-dimensional printer comprising:
a framed structure supporting a movable printing arm, the printing arm operative to print a three-dimensional (3-D) object;
a stabilizing arm coupled with and extending away from the framed structure; and
one or more stabilizing devices coupled with the framed structure to prevent movement of the framed structure in a micro-gravity environment.

2. The micro-gravity three-dimensional printer as recited in claim 1, wherein the one or more stabilizing devices include at least one of a thruster or a gyro.

3. The micro-gravity three-dimensional printer as recited in claim 1, further comprising one or more media tanks coupled with the frame structure to store material to create the three-dimensional object.

4. The micro-gravity three-dimensional printer as recited in claim 3, further comprising one or more tab bars extending outward from the framed structure and coupled with the one or more media tanks.

5. The micro-gravity three-dimensional printer as recited in claim 1, further comprising a material platform coupled to the framed structure, the material platform operative to receive material released from the printing arm to form the 3-D object.

6. The micro-gravity three-dimensional printer as recited in claim 5, wherein the printing arm is configured to rotate and move toward or away from the material platform during print of the 3-D object.

7. The micro-gravity three-dimensional printer as recited in claim 1, wherein the stabilizing arm is integrally coupled with a counterbalance disposed about a midpoint of the stabilizing arm.

8. The micro-gravity three-dimensional printer as recited in claim 7, wherein the counterbalance is a movable counterbalance configured to move laterally along the stabilizing arm in response to Newtonian forces or gravitational forces on the printer.

9. The micro-gravity three-dimensional printer as recited in claim 3, further comprising one or more print heads disposed on one end of the printing arm through which material from the media tanks flow to create the three-dimensional object.

10. The micro-gravity three-dimensional printer as recited in claim 9, further comprising an ultra-violet light source that includes a plurality of ultra-violet array elements coupled around the one or more print heads to direct ultra-violet light on the three-dimensional object.

11. A method for printing three-dimensional (3-D) object in a micro-gravity environment comprising:
supporting a movable printing arm with a frame structure of a 3-D printer;
coupling a stabilizing arm to the framed structure;
preventing movement of the framed structure in a micro-gravity environment using one or more stabilizing devices coupled with the framed structure; and
printing a 3-D object with the printing arm.

12. The method for printing the three-dimensional (3-D) object in the micro-gravity environment as recited in claim 11 further comprising:
coupling a movable counterbalance to the stabilizing arm; and
moving the counterbalance laterally along the stabilizing arm in response to Newtonian forces or gravitational forces on the printer.

13. The method for printing the three-dimensional (3-D) object in the micro-gravity environment as recited in claim 11 further comprising:
generating a plug coupled with the frame structure from material released from the printing arm to form the 3-D object in a shape of a circular platter.

14. The method for printing the three-dimensional (3-D) object in the micro-gravity environment as recited in claim 13 further comprising:
rotating the printing arm about an axis extending through one end of the printing and moving the printing arm toward or away from the platter during the print of the 3-D object to increase a size of the plug in forming the 3-D object.

15. The method for printing the three-dimensional (3-D) object in the micro-gravity environment as recited in claim 11 wherein the one or more stabilizing devices include at least one of a thruster or a gyro, and wherein the method further includes counteracting reactionary movement of the framed structure with the one or more stabilizing devices in the micro-gravity environment during the print of the 3-D object.

16. The method for printing the three-dimensional (3-D) object in the micro-gravity environment as recited in claim 11 further comprising:
coupling one or more media tanks with the frame structure;
storing material in the one or more media tanks; and
creating the three-dimensional object with the material stored in the one or more media tanks.

17. The method for printing the three-dimensional (3-D) object in the micro-gravity environment as recited in claim 16, wherein and creating the three-dimensional object with material stored in the one or more media tanks includes flowing the material from the one or more media tanks via one or more print heads disposed on one end of the printing arm to create the three-dimensional object.

18. The method for printing the three-dimensional (3-D) object in the micro-gravity environment as recited in claim 17, further comprising direct ultra-violet light on the three-dimensional object from an ultra-violet light source that includes a plurality of ultra-violet array elements coupled around the one or more print head.

19. A micro-gravity three-dimensional (3-D) printer comprising:
a framed structure supporting a movable printing arm, media tanks and a material platform, the printing arm rotatably coupled with the frame structure at one end and coupled with one or more print heads disposed at another end of the printing arm, configured to print a 3-D object on the platform by injecting material in the media tanks via the print head;
a stabilizing arm coupled with and extending away from the framed structure having a movable counterbalance configured to move laterally along the stabilizing arm in response to Newtonian forces or gravitational forces on the printer; and
one or more stabilizing devices that include one or more thrusters coupled with the framed structure to prevent movement of the framed structure in a micro-gravity environment when printing the 3-D object.

20. The micro-gravity three-dimensional printer as recited in claim 19, further comprising an ultra-violet light source array that includes a plurality of ultra-violet array elements coupled with the printing arm and at least partially surrounding the one or more print heads to direct ultra-violet light on the 3-D object.
